(19) United States
(12) Patent Application Publication
(10) Pub. No.: US 2005/0037316 A1
(43) Pub. Date: Feb. 17, 2005

(54) Interproximal dental appliance

(76) Inventor: Brian David Sholder, Lincoln, MT (US)

Correspondence Address: LADAS & PARRY LLP, 224 SOUTH MICHIGAN AVENUE, SUITE 1200, CHICAGO, IL, 60604, US

(21) Appl. No.: 10/641,478

(22) Filed: Aug. 14, 2003

(51) Int. Cl. A61C 3/03

(52) U.S. Cl. 433/119

(57) ABSTRACT

The invention is an interproximal dental appliance, comprising an over-molded interproximal cleaning tip for insertion into interproximal spaces between teeth, and further comprising an adapter arm for detachably coupling the over-molded interproximal cleaning tip to the interproximal dental appliance, where a sonic energy director located between the adapter arm and a sonic power generator transfers acoustic vibration energy through the adapter arm to the over-molded interproximal cleaning tip. The adapter arm includes an angled end to enable positioning the over-molded interproximal cleaning tip into the interproximal spaces between teeth.

### FIELD OF THE INVENTION

This invention relates to dental hygiene devices and more specifically concerns a power-driven acoustic toothbrush having a timing mechanism, a load sensor and an over-molded cleaning tip as a system for cleaning the interproximal spaces.

### BACKGROUND OF THE INVENTION

The general structure of teeth and gums in the human mouth takes the form of abutting tooth structures partially embedded in bone with the interproximal region between adjacent teeth being generally filled with gingival papilla or gum structure. Where there has been periodontal surgery or periodontal disease, the gingival papilla and bone structure, which formerly filled the interproximal region, will have deteriorated significantly. The result is an interproximal space that provides an excellent environment for accumulation of food particles and the build up of bacteria and plaque. A vertical cross-sectional view of this interproximal space resembles a triangle in the region above the healthy gum line. Below the gum line, the interproximal space resembles furrows extending along each tooth root and separated by a mound of gingival papilla. These furrows of space are referred to as the dental “sulcus” which is between a tooth and adjacent gingival papilla.

It is well known that build-up of plaque on the surface of a tooth is a significant contributor to tooth decay as well as associated tooth and gum diseases. Tooth brushing is generally ineffective in cleansing the spaces and tunnels between the teeth. Concave surfaces may meet resulting in a very difficult to clean concavity between the teeth. It is in these spaces and tunnels where most of the gum problems and many cavities develop. While there are devices that have been invented to clean these areas, these devices have not been sufficiently convenient and effective for them to provide a significant contribution to the public dental health. The brushing of one's teeth with a standard toothbrush is recognized as being inadequate to remove plaque from all surfaces of a tooth, especially those surfaces facing an adjacent tooth, as well as those surfaces in the dental sulcus between the tooth and the interproximal gingival papilla. Moreover, it is beneficial to gently stimulate the gum tissue surrounding the teeth but the brushing of one's teeth with the standard toothbrush often provides insufficient tissue stimulation for good oral health.

Conventional toothbrushes, including both manual and power-driven embodiments, attempt to produce the desired cleansing effect by scrubbing the surfaces of the teeth to remove dental plaque. Flossing is typically recommended in addition to brushing to reach those tooth areas that cannot be reached by a brush.

However, it is well known that flossing is inconvenient and difficult to perform. Further, flossing does not clean concave surfaces or concavities that exist between teeth. Consequently, only about 15% of the population practice flossing regularly. In addition, conventional brushing action, particularly over an extended period of time, can result in undesirable wear on teeth surfaces. In order to improve on the brushing/flossing combination, a number of different technical approaches have been used, with varying success. A first category or group of devices involves the water jets. Representative examples of patents in this group include U.S. Pat. No. 3,227,158 and U.S. Pat. No. 3,522,801. Typically, these devices use a pulsating, highly directed stream of fluid to remove material from around the teeth. However, these devices have significant disadvantages, including a requirement of relatively high water pressure. Generally, these devices are not very effective in removing plaque. In addition, bacteria spread sometimes results from use of these devices.

A second group of devices includes those in which a brush is vibrated at an ultrasonic frequency rate to produce a cavitation effect that in turn results in the desired cleansing. U.S. Pat. No. 3,335,443 and U.S. Pat. No. 3,809,977 are examples of such devices. The primary difficulty with such devices is the requirement of providing energy through the bristles at ultrasonic frequencies, which are substantially higher than the resonant frequency of the bristles, resulting in very low efficiency of energy transfer to the tips of the applicator. Safety issues may be significant with such devices, due to the application of ultrasonic energy to living tissue.

In still another group are devices which operate at low sonic frequencies but which also allegedly produce a cavitation effect. U.S. Pat. Nos. 3,535,726 and 3,676,218 are representative of this group. It is questionable, however, that a vaporous cavitation effect is actually produced by these devices, particularly for those which are hand held and powered by batteries.

Lastly, some devices operate in the low audio frequency range (200-500 Hz), and produce what is characterized as mild cavitation, combining that effect with conventional bristle scrubbing action to achieve cleansing. An example of such a device is shown in U.S. Pat. No. 4,787,747. This device is effective a to some extent in disrupting plaque colonies. However, the “cavitation” produced by this device, which in fact is not vaporous cavitation (vaporous cavitation being often referred to as “true” cavitation) does not extend beyond the tips of the bristles, and therefore the device is not particularly effective in the inter-dental and subgingival areas of the teeth where enhanced cleansing is needed. Toothbrushes of many types are known, including many acoustic cleaning devices, as presented in U.S. Pat. Nos. 5,309,590 and 5,378,153. However, these devices are not particularly effective at cleaning between teeth, where the direct brushing action cannot reach.

With devices in the low audio frequency range, cavitation is often dampened or even negated when conventional bristle scrubbing action is used. Typically, when scrubbing action is applied, brush head speed is reduced below the effective cavitation frequency range due to load pressure on the acoustic motion generator. Toothbrushes having load sensors with alarm signals are known, including appliances that operate in the acoustic frequencies, as presented in U.S. Pat. Nos. 5,815,872 and 5,784,742. However, when these devices are used for cleaning between narrow separations between teeth, significant brush pressure on the teeth is required to force the brush tip into the tight spaces, resulting in excessive load pressure and alarm signals without substantial cleaning to the narrow regions.

Dental appliances specialized for cleaning interproximal spaces are known useful tools for plaque removal and for tissue stimulation. Various woven, twisted or bonded fiber floss-type linear media are available for cleaning dental bridges and implants. The cleaning effectiveness of these traditional products tends to be limited because the cross-sectional area of these products tends to be reduced when tension is applied. Consequently, traditional fiber-based products have a limited capability in reaching and cleaning areas under bridges and implant prostheses that may be concave or which may have irregular surface contours. Further, fiber-based products tend to snag and fray or shred on sharp edges in the mouth.

There are different reasons why many people do not floss with presently available dental floss. Among them:

1. Discomfort when flossing;

2. Time required to floss;

3. Difficulty in inserting floss between teeth;

4. Floss often fragments or breaks; and

5. Floss fragments lodge between teeth and are difficult to remove.

6. Hygiene concerns of placing fingers in mouth.

The known and readily available devices for interproximal cleaning are manually operated and require great dexterity and patience to successfully clean the teeth.

Pick-type interproximal dental cleaners/tissue stimulators typically include a tapered point for cleaning interproximal spaces between the teeth and stimulating soft tissue in the interproximal space. These products are of three basic types: (1) soft wood (See for example, U.S. Pat. No. 4,660,583); (2) hard molded plastic; and (3) molded rubber. Soft wood interproximal cleaners/stimulators lack durability and tend to soften, splinter, fray and break after being used in the mouth for a relatively short period of time. These products may also lack the strength necessary to be pushed into restricted interproximal spaces. The natural material utilized can demonstrate considerable variation in hardness and strength from item to item. Hard plastic interproximal cleaners/stimulators, on the other hand, typically have sharp points and sharp edges that can injure soft tissue if used carelessly or aggressively. Further, the lack of flexibility of these products severely limits their ability to clean interproximal tooth surfaces. Traditional molded rubber tips are primarily beneficial for soft tissue stimulation and are not effective for thorough plaque removal.

Prior art interproximal brushes typically comprise fine nylon bristles retained by a twisted wire core. The brushes have a round cross-section and may be cylindrical or conical in profile. Interproximal brushes are typically of several basic types: (1) a brush set at a 90 to 100 degree angle to a handle that is similar to a toothbrush handle; and (2) a small, straight interproximal brush about 2.5 inches long with a handle normally held between the thumb and one or two fingers; (3) tufted brushes such as the SULCABRUSH; and (4) plastic foam brushes comprising a plastic inner stem and an outer soft foam cover. The twisted core wires of many contemporary brushes are coated with TEFLON to prevent irritation of the nerves of teeth caused by small electrical voltages generated in the mouth when the dissimilar metals used in the brush core wires and dental restorations, respectively, create a battery-effect in the acid environment of the mouth. The cores of such prior art brushes are capable of withstanding very limited bending forces, the brush bristles lack durability, and the replaceable interproximal brushes used with toothbrush-style handles must be changed frequently. Placing a new brush into an existing handle is typically inconvenient and time consuming. In some products, the stem end of the brush tends to protrude from the back of the handle and must be carefully bent down or to the side to avoid leaving a protrusion that can irritate or even penetrate tissues inside of the lips or cheek. The core of the brush presents many small crevices that can be penetrated by microorganisms. If, as is frequently the case, a brush is used to clean periodontally infected areas, the porous quality of the brush has the potential to contribute to periodontal infections in previously uninfected areas of the mouth.

Known interproximal brushes are used with sonic power generator devices to promote more effective dental cleaning, which include tufted brushes and pick-type members. Though these devices have shown improvement in cleaning efficacy, they have limitations in useful lifetime and are effective in specialty applications. For example, the tufted brush is effective for disrupting plaque from interdental space, whereas the pick-type member is effective in scraping plaque from teeth walls. Neither of these instruments is capable of effectively promoting complete oral hygiene.

The foregoing and other limitations and shortcomings in products for cleaning interdental or interproximal spaces of the traditional prior art have been widely recognized for many years. Various inventors have developed numerous inventions in an attempt to overcome the limitations of the traditional prior art. See, for example, U.S. Pat. Nos. 4,660,583; 4,911,187; and 4,280,518.

While each of these inventions offers one or more novel features directed at overcoming the limitations or shortcomings of the traditional prior art, each of these products present, individually and collectively, limitations that fail to satisfy all of the criteria for a clinically effective interproximal cleaning product necessary for gaining wide acceptance by dental professionals and dental patients.

The known and readily available devices for interproximal cleaning are manually operated and require great dexterity and patience to successfully clean the teeth. Accordingly, there continues to be a need for novel appliances for cleaning interproximal spaces that both overcome the limitations and shortcomings of the traditional prior art and satisfy the four criteria for effective interproximal cleaning products listed above. The present invention fulfills these needs and provides other related advantages.

### BRIEF DESCRIPTION OF THE DRAWINGS

FIG. 1 illustrates a perspective view of the interproximal dental appliance device.

FIG. 2 depicts the interproximal over-molded dental appliance cleaning tip.

FIG. 3 depicts the interproximal over-molded dental appliance cleaning tip vibration paths.

FIG. 4 depicts a block diagram of the functional elements of the interproximal dental appliance device.

### DETAILED DESCRIPTION OF THE PREFERRED EMBODIMENT

As shown in the drawings for purpose of illustration, the present invention is concerned with interproximal dental appliance devices.

The invention is an interproximal dental appliance, comprising an over-molded interproximal cleaning tip for insertion into interproximal spaces between teeth, and further comprising an adapter arm for detachably coupling the over-molded interproximal cleaning tip to the interproximal dental appliance, where a sonic energy director located between the adapter arm and a sonic power generator transfers acoustic vibration energy through the adapter arm to the over-molded interproximal cleaning tip. The adapter arm includes an angled end to enable positioning the over-molded interproximal cleaning tip into the interproximal spaces between teeth.

The over-molded interproximal cleaning tip is of generally conical shape and includes a plurality of elastomeric flat-faced flanges extending perpendicularly outwardly from the base to the tip in a staggered pattern, where the flanges include a first set spaced from one another along a longitudinal axis of the base and radially aligned with one another about the longitudinal axis. An exemplar device having a frusto-conical aspect is disclosed in U.S. Pat. No. 5,775,346, which is incorporated herein by reference in its entirety. A radially aligned second set longitudinally are disposed in an alternating manner between adjacent flanges of the first set along the longitudinal axis of the base, wherein the first set of flanges are radially offset from the second set of flanges. The flanges are of Shore A hardness elastomeric urethanes or silicones in similar hardnesses. The flanges collectively form a generally frusto-conical ribbed segment, wherein the base is generally frusto-conical. The base comprises a bi-material composite structure, including a relatively stiff, resilient core, and a sheath over the core is integrally formed with the flanges.

The adapter arm holds at a first end the over-molded interproximal cleaning tip at about a 100-degree angle, and has a universal coupler at the second end for attaching to a plurality of sonic energy director devices.

The sonic energy generator is coupled to a load sensor for monitoring generator workloads, where increases in loads occur when excessive pressure is applied between the over-molded interproximal cleaning tip and oral surfaces during cleaning operation. The sonic power generator can include a timer for defining a cleaning period, wherein the timer turns off the sonic power generator at the end of the cleaning period. The sonic power generator moves the over-molded interproximal cleaning tip in a sundry of directions including linear directions transverse to the adapter arm length, arced oscillation about the longitudinal axis of the adapter arm, circular precession about the cleaning tip longitudinal axis, and to rotate or spin about the over-molded interproximal cleaning tip longitudinal axis. Further, the sonic power generator provides a random vibrating direction, or a vibration direction selectively controlled for transverse, lateral, longitudinal, random and rotational motion cleaning. The sonic vibration frequency of the over-molded interproximal cleaning tip is selectively variable between 20 Hz and 400 Hz and the over-molded cleaning tip velocity is at least 2.0 meters per second, wherein the amplitude of movement of the over-molded interproximal cleaning tip is within the range of 0.5 mm to 6 mm, and the frequency is less than the resonant frequency of the over-molded interproximal cleaning tip.

The cleansing action reaches the interdental and gingival areas without the over-molded interproximal cleaning tip being in the immediate vicinity of the gingival area. The shear stress on dental plaque created by action of the apparatus is greater than 50 Pa at a distance of 2 mm from the tips of the bristles. The over-molded interproximal cleaning tip produces an acoustic pressure of at least 1.5 kPa. The vibration of the over-molded interproximal cleaning tip is sufficient to support cavitation at the teeth and the surrounding area.

A method for cleaning teeth and interdental and gingival areas includes using a toothbrush apparatus having a moving arm with an over-molded interproximal cleaning tip at one end thereof, and comprising the steps of providing medicament in the vicinity of the teeth, interdental and gingival areas to be cleaned. Cleaning action is accomplished by moving the adaptor arm and hence the over-molded interproximal cleaning tip such that the over-molded cleaning tip moves through the medicament at a velocity greater than approximately 1.5 meters per second, thereby producing a cleansing effect, through corresponding movement of the medicament, beyond the tips of the bristles. The cleansing effect reaches the interdental and gingival areas without the tip of the over-molded interproximal cleaning tip being in the immediate vicinity thereof. The medicament contains abrasive particles, oxygen-releasing agents, anti-bacterial agents, desensitizers, and fluoride gels.

The method for cleaning teeth, interdental and gingival areas using a toothbrush apparatus having a moving arm with an over-molded interproximal cleaning tip at one end thereof, further includes a frequency of movement of the tip of the over-molded interproximal cleaning tip between 40 Hz and 500 Hz and wherein the amplitude of movement is within the range of 0.5 mm to 6 mm. The frequency is less than the resonant frequency of the over-molded cleaning tip, and the movement of the over-molded cleaning tip produces an acoustic pressure of at least 1.5 kPa.

The method for cleaning teeth and interdental and gingival areas, using a toothbrush apparatus having a moving arm with an over-molded interproximal cleaning tip at one end thereof, includes motion of the over-molded interproximal cleaning tip in a single plane, such that when the over-molded cleaning tip is positioned horizontally against the tooth, the tip of the over-molded cleaning tip moves vertically toward and away from the gum line. Alternatively the motion of the over-molded cleaning tip rotates through a preselected arc, circle or random pattern in a single plane.

Additionally, the method for cleaning teeth, interdental and gingival areas, using a toothbrush apparatus having a moving arm with an over-molded interproximal cleaning tip at one end thereof, includes a load sensor to monitor pressure applied between the over-molded interproximal cleaning tip and oral surfaces, then turns off the toothbrush apparatus if a predefined pressure is exceeded. Further, a timing device monitors the duration of a cleaning period and terminates the cleaning session when the period expires.

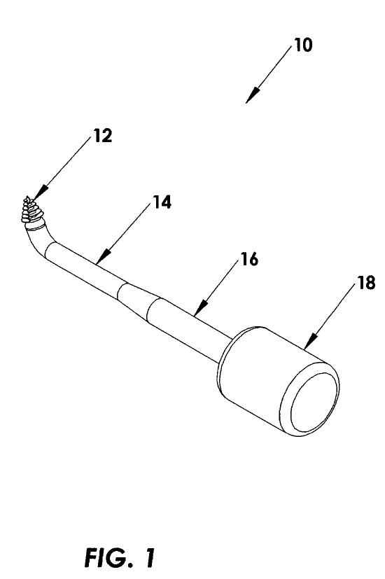

In accordance with the present invention with reference to FIG. 1 the interproximal dental cleaning device 10 comprises a detachable interproximal cleaning tip 12 having a core substrate with a soft rubber over-molded sheathing, an adapter arm 14 for supporting the interproximal cleaning tip 12 at an angle of about 110 degrees at a first end and for attaching to a sonic energy director 16 at a second end. The sonic energy director 16 fixedly couples to a sonic power generator 18, where the sonic power generator 18 creates movement in to the sonic energy director 16 and thus causing sonic movement in the adaptor arm 14 and over-molded interproximal cleaning tip 12. The adapter arm 14 is preferably a universal coupler that enables convenient attachment to a plurality of sonic energy directors 16.

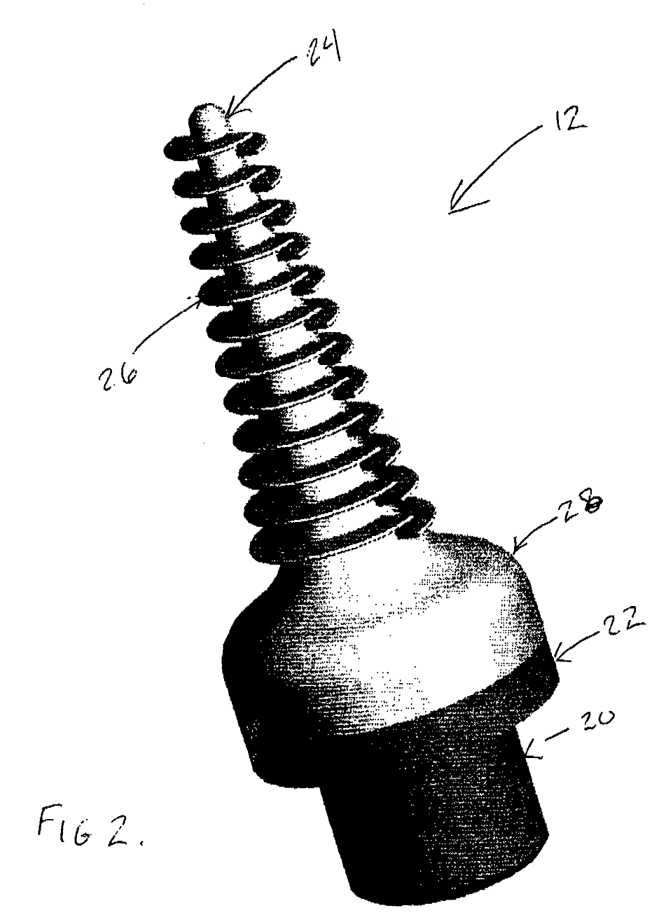

As shown in FIG. 2, the over-molded interproximal cleaning tip 12 is shown to include a base 20 and a head portion 22. The head portion 22 of the interproximal cleaning tip 12 includes an elongated base 24 configured for insertion into interproximal spaces between teeth (not shown), and a plurality of elastomeric flat-faced flanges 26 which extend perpendicularly outwardly from the elongated base 24 in a staggered pattern. The pattern and configuration of the elastomeric flat-faced flanges 26 collectively form a generally frusto-conical ribbed segment about the elongated base 24 that is also generally frusto-conical. This design enhances the retention of additives that may be intended for application to the tooth surface or gums. These additives are often referred to as medicaments or as chemotherapeutic agents. They include, but are not limited to, antibacterial agents, fluoride gels, desensitizing gels and agents, and toothpastes, where the toothpaste may contain abrasive admixtures. For brevity, the term “medicament” is used to indicate these classes of additives herein.

Because interproximal embrasure (the spaces between teeth) varies from nonexistent to 5 mm to 6 mm or larger, one key to creating a successful interproximal dental appliance is its ability to work effectively in the widest possible range of aperture sizes and shapes. The ability of the current invention to clean interproximal concavities is an important improvement over the prior art devices. Many prior art devices are extremely limited or simply unworkable because of a lack of adaptability. Further, an important requirement for a useful device is the ability of the device to provide cleaning action without producing excessive irritation of soft tissues. It is believed that a majority of the dental patients who need to use interproximal dental appliances suffer from periodontal disease and have unhealthy oral tissues that are tender and easily irritated. Cleaning action versus protection of soft tissues requires a trade-off, but hard plastic devices with sharp edges are not satisfactory. Additionally, hard plastic devices are typically not able to accommodate to the often complex and irregular geometry of natural tooth structure and dental prostheses or restorations.

The interproximal cleaning tip 12 is preferably produced from a relatively high-tensile, relatively low durometer elastomeric polymer and molded as an integral unit. Alternatively, the base 20 may comprise a bi-material composite structure including a relatively stiff, resilient core (not shown), and an outer sheath 28 over the core that is integrally formed with the flanges 26. In an alternative embodiment, the central core is a monofilament, twisted fiber or woven thread about which the outer sheath 28 and the flanges 26 are molded. It should be understood, however, that whether or not a core is included as part of the base 20, the over-molded interproximal cleaning tip 12 will remain flexible so as to easily contour around the orthodontic brackets and wires or implant abutments, as well as between and around ones teeth.

FIG. 2 illustrates one embodiment of the over-molded interproximal cleaning tip 12 wherein a bi-material composite structure is utilized within the head portion 22. The outer sheath 28 and the flanges 26 are formed of a relatively soft, deformable and elastic material that is fully bonded to a stiff, resilient polymer core that provides resistance to the compressive, shear and bending moment forces generated by use. The core (not shown) is simply an extension of and integrally molded with the base 20. As part of the bi-material composite structure, the elastic outer sheath 28, in conjunction with the adhesive bond, actually makes a not insignificant contribution to total resistance to bending and thus makes possible a small but highly significant reduction in the required diameter of the inner core (not shown) relative to what would be required with any known material soft enough to be brought into vigorous contact with soft tissues. While many potentially suitable polymers exist that may be utilized for both the outer sheath 28 and the core (not shown), it is most desirable to utilize materials, which combine suitable mechanical properties, good manufacturing characteristics and relative economy. For the outer sheath 28 and flanges 26 the primary preferred polymers are Shore A hardness elastomeric urethanes or silicones in similar hardnesses. The primary polymers for the base 20 and core (not shown) are “hard” (non-elastomeric) modified urethanes, modified ABS, silicones, polymers, and polypropylenes.

The outer sheath 28 encapsulates an end of the core (not shown) and forms a flexible leader, and is bonded to the core (not shown) utilizing any suitable adhesive. Presently it is believed that the best are cyanacrylates and various anaerobics, especially the more flexible members of these families. Alternatively, it is possible to use solvent bonding when a flexible, elastomeric urethane outer sheath is used in conjunction with a rigid, modified urethane core (not shown). Theoretically, solvent bonding provides the advantage of uniting the two urethane materials without introducing a third substance. The two different urethane based materials interpenetrate and merge within a narrow, amorphous zone. All volatile elements of the solvent migrate through the outer sheath 28 and dissipate into the atmosphere. With solvent bonding it is anticipated that forces will be more uniformly distributed within the composite structure yielding an absence of stress concentrations.

The over-molded interproximal cleaning tip 12 comprises a relatively firm core plastic substrate of generally frusto-conical shape (not illustrated) and a relatively soft outer layer, where the outer layer includes molded flanges 26, and the flanges collectively form a generally frusto-conical ribbed segment that is useful for moving medicaments for efficient cavitation, in addition to enabling scrubbing action, where the medicaments comprise at least one or a mixture of abrasive particle, oxygen-releasing agent, or anti-bacterial agent. The cleansing action in the interproximal region occurs by direct contact with the over-molded interproximal cleaning tip 12, and in the immediate vicinity thereof where the frequency is less than the resonant frequency of the over-molded interproximal cleaning tip 12. It is known that the shear stress on dental plaque created by action of acoustic cleaning apparatus is greater than 50 Pa at a distance of 2 mm from the tips of the brush-type cleaning tip. The relatively firm core of the over-molded cleaning tip enables a higher resonate frequency over conventional brush-type cleaning tips and thus more effective cavitation at greater distances wherein the movement of the over-molded interproximal cleaning tip 12 produces an acoustic pressure of at least 1.5 kPa. The frequency of movement of the over-molded interproximal cleaning tip 12 is within the range of 40 and 500 Hz, and the amplitude of movement is within the range of 0.5 to 6 mm.

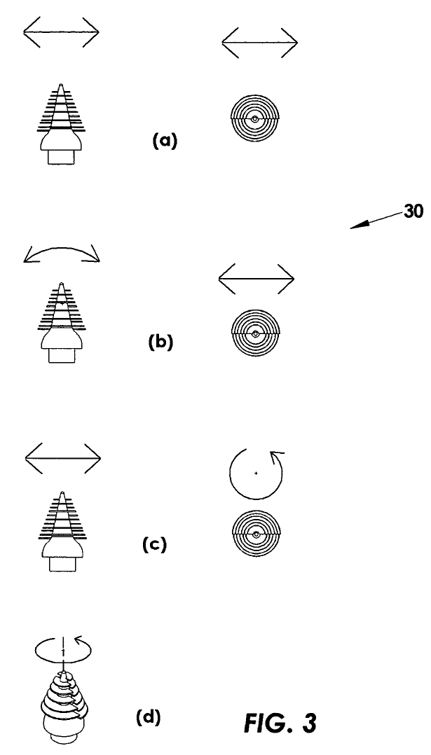

Sonic power generation can be accomplished using various technologies and devices including rotating electric motors, oscillating solenoids and vibrating piezoelectric devices, and when combined with gears, drives and differentials, are capable of creating a sundry of sonic vibration paths including linear, arced, circular, spinning, and elliptical among others. FIG. 3 depicts some of the sonic paths 30 the over-molded interproximal cleaning tip 12 follows in operation. FIG. 3a depicts a linear back and forth movement where the adapter arm 14 (not shown) translates linearly from side to side and hence moving the interproximal cleaning tip linearly from side to side. With the vibrating tip in a single plane, the cleaning tip is positioned horizontally against the teeth, and is suitably disposed to move vertically in a reciprocating fashion toward and away from the gum line. As depicted, FIG. 3a illustrates a side view and a top view of the over-molded interproximal cleaning tip 12 operating in a linear translation mode. The length of the translation path or amplitude of movement is within a range of 0.5 mm to 6.0 mm, in a frequency range between 40 Hz and 500 Hz.

FIG. 3b depicts an arced sonic vibration path the interproximal cleaning tip 12 follows when the adapter arm 14 (not shown) is oscillated about its longitudinal axis. FIG. 3b depicts a side view and a top view of the interproximal cleaning tip 12, where the side view oscillation path is depicted by an arced double arrow, and the top view oscillation path is depicted by a linear double arrow. The arced oscillation is from 1 degree to 15 degrees. The length of the translation path or amplitude of movement is within a range of 0.5 mm to 6.0 mm, in a frequency range between 40 Hz and 500 Hz, and the arced oscillation is from 1 degree to about 10 degrees at about 2.0 meters per second.

FIG. 3c depicts a circular sonic vibration path that the over-molded interproximal cleaning tip 12 follows, when the adapter arm 14 (not shown) is oscillated in a circular pattern along its horizontal plane. Shown are the side view and a top view of the over-molded interproximal cleaning tip 12, where the side view oscillation path is depicted by a linear double arrow, and the top view oscillation path is depicted by a circular arrow. The diameter of the circular path or amplitude of movement is within a range of 0.5 mm to 6.0 mm, in a frequency range between 40 Hz and 500 Hz.

FIG. 3d depicts an over-molded interproximal cleaning tip 12 that spins on its central axis, where the central axis is shown as a dashed line projecting from the top of the interproximal cleaning tip 12. The spinning action is in a frequency range between 40 Hz and 500 Hz.

One embodiment of the invention enables the vibrating motion to be selectively controlled for transverse, lateral, longitudinal, rotational and random motion direction, and having vibrating motion velocity of at least 2.0 meters per second.

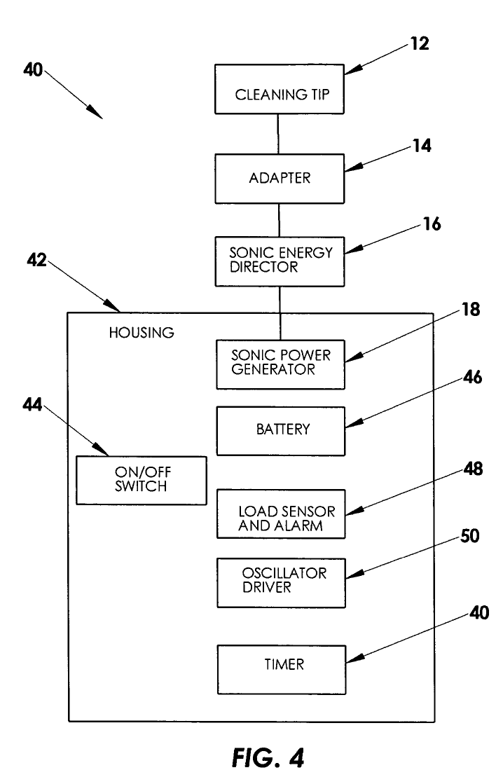

Referring now to FIG. 4, where the elements of the interproximal dental appliance invention are depicted in an interdental cleaning apparatus element diagram 40. The elements of the invention include interproximal cleaning tip 12, adapter arm 14, sonic energy director 16, sonic power generator 18, housing 42, on/off switch 44, battery 46, load sensor and alarm 48, oscillator driver 50, and timer 52. The housing 42 is for fixedly supporting the sonic power generator 18. The load sensor has a predefined pressure limit of about 60 kPa, and the timing device that monitors the cleaning duration has a means to terminate the vibration.

Obviously, many modifications and variations of the present invention are possible in light of the above teachings. It is therefore to be understood that, within the scope of the appended claims, the invention may be practiced otherwise than as specifically described.

1. An interproximal dental appliance suitable for cleaning teeth and interdental and gingival areas, comprising:
a sonic power generator;
a sonic energy director attached to said sonic power generator;
an over-molded interproximal cleaning tip having a longitudinal axis along an elongated base of generally frusto-conical shape suitable for insertion in interdental spaces between teeth; and
an adapter arm for detachably holding at a first end said interproximal cleaning tip and attaching to a second end said sonic energy director wherein said adapter has a longitudinal axis.

2. The interproximal dental appliance according to claim 1, wherein
said over-molded interproximal cleaning tip having an elastomeric sheath attached to said elongated base with a plurality of elastomeric flat-faced flanges extending perpendicularly outward from said longitudinal axis to said interproximal cleaning tip in a staggered pattern;
said flanges including a first set spaced from one another along a longitudinal axis of said elongated base and radially aligned with one another about said longitudinal axis; and
a radially aligned second set longitudinally disposed in an alternating manner between adjacent flanges of the first set along the longitudinal axis of the base, wherein said first set of flanges is radially offset from said second set of flanges.

3. The interproximal dental appliance according to claim 1, wherein said adapter arm holds said over-molded interproximal cleaning tip at an angle of about 100 degrees.

4. The interproximal dental appliance according to claim 1, wherein said adapter arm has a universal coupler at said second end for attaching to a plurality of sonic energy director devices.

5. The interproximal dental appliance according to claim 1, wherein:
said sonic energy generator is coupled to a load sensor for monitoring generator workloads; and
increases in said generator workloads occur when an excessive pressure is applied between said over-molded interproximal cleaning tip and oral surfaces during a cleaning operation.

6. The interproximal dental appliance according to claim 1, wherein
said sonic power generator includes a timer for defining a cleaning period duration; and
said timer turns off said sonic power generator at the end of said cleaning period duration.

7. The interproximal dental appliance according to claim 1, wherein said sonic power generator moves said over-molded interproximal cleaning tip in a linear direction transverse to said adapter length.

8. The interproximal dental appliance of claim 7, wherein said generator moves from 0.5 mm to 6 mm.

9. The interproximal dental appliance according to claim 1, wherein said sonic power generator moves said over-molded interproximal cleaning tip in an arced oscillation about said longitudinal axis of said adapter arm.

10. The interproximal dental appliance according to claim 9, wherein said arced oscillation is from 1 degree to 15 degrees.

11. The interproximal dental appliance according to claim 1, wherein said sonic power generator moves said over-molded interproximal cleaning tip in a circular precession.

12. The interproximal dental appliance according to claim 11, wherein said circular precession is from 0.5 mm to 6 mm diameter.

13. The interproximal dental appliance according to claim 1, wherein said adapter arm enables said interproximal cleaning tip to rotate about said longitudinal axis of said over-molded interproximal cleaning tip.

14. The interproximal dental appliance according to claim 1, wherein said over-molded interproximal cleaning tip rotates about said cleaning tip longitudinal axis.

15. The interproximal dental appliance according to claim 1, wherein said sonic power generator provides a vibrating motion.

16. The interproximal dental appliance according to claim 15, wherein said vibrating motion is selectively controlled for transverse, lateral, longitudinal, rotational and random direction.

17. The interproximal dental appliance according to claim 15, wherein said vibrating motion of said over-molded interproximal cleaning tip is selectively variable between 40 Hz and 500 Hz.

18. The interproximal dental appliance according to claim 15, wherein said vibrating motion provides a over-molded interproximal cleaning tip velocity of at least 2.0 meters per second.

19. An interproximal dental appliance over-molded interproximal cleaning tip, comprising:
an elongated base having a first end and having a second end including a threadable leader at said first end of said elongated base that is configured for insertion into interproximal spaces between teeth;
a handle at said second end of said elongated base;
a plurality of elastomeric flat-faced flanges extending perpendicularly outwardly from said base between said threadable leader and said handle in a staggered pattern, said flanges including a first set of flanges spaced from one another along a longitudinal axis of said base and radially aligned with one another about said longitudinal axis; and
a radially aligned second set of flanges longitudinally disposed between adjacent flanges of the first set along said longitudinal axis of said base, wherein said first set of flanges is radially offset from said second set of flanges.

20. The dental appliance according to claim 19, wherein said flanges are comprised of elastomeric urethanes or silicones having similar hardnesses.

21. The dental appliance according to claim 19, wherein
said flanges collectively form a generally frusto-conical ribbed segment; and
said base is generally frusto-conical.

22. The dental appliance according to claim 19, wherein said base comprises a bi-material composite structure including a relatively stiff, resilient core, and a sheath over said resilient core integrally formed with said flanges.

23. A dental hygiene device for cleaning teeth and interdental and gingival areas, comprising:
a body member which includes an adapter arm having a first end and a second end mounted for movement;
an over-molded interproximal cleaning tip, said interproximal cleaning tip being detachably fixed to said first end of said adapter arm; and
means in said body member for moving said adapter arm and hence said interproximal cleaning tip such that said cleaning tip moves at a velocity which is sufficient to produce a cleansing action with a dentifrice fluid beyond said cleaning tip.

24. The dental hygiene device according to claim 23, wherein said velocity of said interproximal cleaning tip is at least 2.0 meters per second.

25. The dental hygiene device according to claim 23, wherein said cleansing action has suitable energy to reach the interdental and gingival areas without said interproximal cleaning tip being in the immediate vicinity thereof.

26. The dental hygiene device according to claim 23; wherein
said means for moving said adapter arm results in a frequency of movement of said interproximal cleaning tip between 40 Hz and 500 Hz.

27. The interproximal dental appliance according to claim 26; wherein said frequency of movement of said interproximal cleaning tip has an amplitude of movement between 0.5 mm to 6 mm.

28. The dental hygiene device according to claim 26, wherein said frequency of movement is less than the resonant frequency of said interproximal cleaning tip.

29. The dental hygiene device according to claim 23, wherein a shear stress on dental plaque created by action of said interproximal cleaning tip is greater than 50 Pa at a distance of 2 mm from said cleaning tip.

30. The dental hygiene device according to claim 23, wherein said movement of said interproximal cleaning tip produces an acoustic pressure of at least 1.5 kPa.

31. The dental hygiene device according to claim 23, wherein
said interproximal cleaning tip extends substantially perpendicularly relative to said adapter arm; and
said interproximal cleaning tip moves in a single plane.

32. The dental hygiene device according to claim 23, wherein said interproximal cleaning tip rotates through a preselected arc.

33. The dental hygiene device according to claim 32, wherein said preselected arc is between 1 degree and 10 degrees.

34. A method for using a toothbrush apparatus having a moving arm with a first end and a second end with a frusto-conical over-molded interproximal cleaning tip at said first end suitably disposed for cleaning teeth above a gum line, interdental and gingival areas, comprising the steps of:
providing at least one medicament in the vicinity of the teeth, interdental and gingival areas;
possessing a resonant frequency of said cleaning tip,
vibrating said moving arm in a reciprocating motion and hence vibrating said interproximal cleaning tip, such that said cleaning tip creates an acoustic pressure and moves with a frequency and an amplitude through said medicament at a velocity; and
producing a cleansing effect through corresponding movement of said medicament.

35. The method according to claim 34, wherein said step of vibrating said moving arm yields said velocity greater than 2.0 meters per second.

36. The method according to claim 34, wherein said step of producing a cleansing effect is sufficient to reach the interdental and gingival areas without said cleaning tip being in the immediate vicinity thereof.

37. The method according to claim 34, wherein:
said step of vibrating yields said frequency between 40 Hz and 500 Hz, and
said step of vibrating yields said amplitude within a range of 0.5 mm to 6 mm.

38. The method according to claim 37, wherein said step of vibrating yields said frequency at less than said resonant frequency.

39. The method according to claim 34, wherein said step of vibrating creates acoustic pressure is at least 1.5 kPa.

40. The method according to claim 34, wherein said step of vibrating is in a single plane, such that when said cleaning tip is positioned horizontally against the teeth, said cleaning tip is suitably disposed to move vertically in a reciprocating fashion toward and away from the gum line.

41. The method according to claim 34, wherein said step of vibrating rotates said cleaning tip through a preselected arc.

42. The method according to claim 41, wherein said step of vibrating is through a preselected arc between 1 degree and 10 degrees.

43. The method according to claim 34, wherein said step of providing a medicament includes providing said medicament comprised of abrasive particles.

44. The method according to claim 34, wherein said step of providing a medicament includes selecting said medicament comprised of at least one oxygen-releasing agent or anti-bacterial agent.

45. The method according to claim 34, further comprising the step of providing a load sensor attached to said apparatus having a predefined pressure limit, said load sensor comprised of means of turning off said moving arm when said predefined pressure limit is exceeded.

46. The method according to claim 45, wherein said step of providing a load sensor having a predefined pressure limit is providing said predefined pressure limit is about 60 kPa.

47. The method according to claim 34, further comprising the step of providing said toothbrush apparatus having a timing device that monitors a duration of cleaning and is comprised of means to terminate said vibrating.

48. A dental hygiene device suitable for cleaning teeth, interdental and gingival areas, comprising:
a body member comprised of an adapter arm having a first end and a second end moveably mounted;
an over-molded interproximal cleaning tip, said cleaning tip being detachably fixed to said first end of said adapter arm; and
means in said body member for moving said adapter arm and hence said cleaning tip such that said cleaning tip moves at a velocity greater than 2.0 meters per second, which is sufficient to produce a cleansing action with a medicament beyond said cleaning tip.

49. The dental hygiene device according to claim 48, wherein said velocity is sufficient to support cavitation at the teeth and in the surrounding area.

50. A method of applying medicaments to dental surfaces and interdental areas, comprising the steps of:
selecting an over-molded interproximal cleaning apparatus having a tip;
selecting at least one medicament;
applying said at least one medicament to said over-molded interproximal cleaning apparatus tip;
positioning said tip on said dental surfaces and interdental areas; and
vibrating said tip.

51. The method of claim 50, wherein said step of selecting at least one medicament is selecting a fluoride gel.

52. The method of claim 50, wherein said step of selecting at least one medicament is selecting toothpaste.

53. The method of claim 50, wherein said step of selecting at least one medicament is selecting an antimicrobial agent.

54. The method of claim 50, wherein said step of selecting at least one medicament is selecting a desensitizer.

55. The method of claim 50, wherein said step of vibrating said tip is accomplished at between 40 Hz and 500 Hz.

56. A method of cleaning and of applying medicaments to interdental concavities, comprising the steps of:
selecting an over-molded frusto-conical interproximal cleaning apparatus having a tip;
selecting at least one medicament;
applying said at least one medicament to said over-molded interproximal cleaning apparatus tip;
positioning said tip on said dental surfaces and interdental areas; and
vibrating said tip.
